(19) United States
(12) Patent Application Publication
(10) Pub. No.: US 2024/0178503 A1
(43) Pub. Date: May 30, 2024

(54) BATTERY

(71) Applicant: Rivian IP Holdings, LLC, Plymouth, MI (US)

(72) Inventors: Yann Marie Philippe Pissonnier, Irvine, CA (US); Ki Woon Kim, Milpitas, CA (US); Christopher Hewett, Rancho Santa Margarita, CA (US); Susheel Teja Gogineni, Sunnyvale, CA (US); Jonathan Christopher Wilson, Rancho Mission Viejo, CA (US)

(73) Assignee: Rivian IP Holdings, LLC, Plymouth, MI (US)

(21) Appl. No.: 18/060,051

(22) Filed: Nov. 30, 2022

(51) Int. Cl. H01M 50/289; B60L 50/64; H01M 10/613; H01M 10/6557; H01M 50/204; H01M 50/271

(52) U.S. Cl. CPC H01M 50/289; B60L 50/64; H01M 10/613; H01M 10/6557; H01M 50/204; H01M 50/271; H01M 2220/20

(57) ABSTRACT

An apparatus can include a space between a first battery cell and a second battery cell. The apparatus can include a closure to at least partially surround the space. The space can receive a coolant. The coolant can contact at least a portion of the first battery cell and at least a portion of the second battery cell.

### INTRODUCTION

Electric vehicles can include various electrical components that provide power to the vehicle. The electrical components can be electrically coupled with vehicle components to power the vehicle.

### SUMMARY

An apparatus can facilitate regulating a temperature of one or more battery cells within a battery module or within a battery pack. The apparatus can include at least a first battery cell and a second battery cell positioned apart from one another to define a space between the cells. A closure can at least partially surround the first battery cell, the second battery cell, and the space between the two cells to hermetically seal the space between the two cells. The space can receive pressurized coolant that freely flows between the first battery cell and the second battery cell. The coolant can contact at least a portion of an exterior of each battery cell. The closure can include at least one fluid channel fluidly coupled to the space to provide the coolant to the space. The closure can include at least one fluid channel fluidly coupled to the space to allow the coolant to exit the space. The apparatus can facilitate efficiently cooling the battery cells while increasing an energy density of the vehicle.

At least one aspect is directed to an apparatus. The apparatus can include a space between a first battery cell and a second battery cell. The apparatus can include a closure to at least partially surround the space. The space can receive a coolant. The coolant can contact at least a portion of the first battery cell and at least a portion of the second battery cell.

At least one aspect is directed to a method. The method can include enclosing, by a closure, a first battery cell and a second battery cell positioned apart from the first battery cell to define a space between the first battery cell and the second battery cell. The method can include providing a coolant to the space between the first battery cell and the second battery cell. The coolant can contact at least a portion of the first battery cell and at least a portion of the second battery cell.

At least one aspect is directed to a battery. The battery can include an apparatus. The apparatus can include a first battery cell positioned apart from a second battery cell to define a space between the first battery cell and the second battery cell. The apparatus can include a closure to at least partially surround the space. The space can receive a coolant. The coolant can contact at least a portion of the first battery cell and at least a portion of the second battery cell.

At least one aspect is directed to an electric vehicle. The electric vehicle can include an apparatus. The apparatus can include a space between a first battery cell and a second battery cell. The apparatus can include a closure to at least partially surround the space. The space can receive a coolant. The coolant can contact at least a portion of the first battery cell and at least a portion of the second battery cell.

At least one aspect is directed to a method. The method can include providing an apparatus. The apparatus can include a space between a first battery cell and a second battery cell. The apparatus can include a closure to at least partially surround the space. The space can receive a coolant. The coolant can contact at least a portion of the first battery cell and at least a portion of the second battery cell.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example side view of an electric vehicle, in accordance with implementations.

FIG. 2A depicts an example perspective view of a battery pack, in accordance with implementations.

FIG. 2B depicts an example perspective view of a battery module, in accordance with implementations.

FIG. 2C depicts an example perspective view of a battery cell, in accordance with implementations.

FIG. 2D depicts an example perspective view of a battery cell, in accordance with implementations.

FIG. 2E depicts an example perspective view of a battery cell, in accordance with implementations.

FIG. 3 depicts an example perspective exploded view of an apparatus, in accordance with implementations.

FIG. 4 depicts an example front view of a portion of the apparatus of FIG. 3, in accordance with implementations.

FIG. 5 depicts an example perspective view of a portion of the apparatus of FIG. 3, in accordance with implementations.

FIG. 6 depicts an example side view of a portion of the apparatus of FIG. 3, in accordance with implementations.

FIG. 7 depicts an example illustration of a process, in accordance with implementations.

FIG. 8 depicts an example illustration of a process, in accordance with implementations.

### DETAILED DESCRIPTION

Following below are more detailed descriptions of various concepts related to, and implementations of, methods, apparatuses, and systems of a cooling apparatus. The various concepts introduced above and discussed in greater detail below may be implemented in any of numerous ways.

The present disclosure is directed to an apparatus that can facilitate regulating a temperature of one or more battery cells within a battery module or within a battery pack. The apparatus can include at least a first battery cell and a second battery cell. The first battery cell and the second battery cell can be positioned apart from one another to define a space between the cells (e.g., between an exterior case of the cells). A closure (e.g., a battery pack enclosure, a module enclosure, a lid component, an end cap, a face plate, or another enclosure) can at least partially surround the first battery cell, the second battery cell, and the space between the two cells to hermetically seal the space between the two cells. The space can receive pressurized coolant that freely flows between the first battery cell and the second battery cell. The coolant can contact at least a portion of an exterior of each battery cell. The closure can include at least one fluid channel fluidly coupled to the space to provide the coolant to the space. The closure can include at least one fluid channel fluidly coupled to the space to allow the coolant to exit the space. The closure can include or can couple with at least one tab that protrudes into a portion of the space to facilitate hermetically sealing the space.

The disclosed solutions have a technical advantage of reducing an overall footprint of a vehicle, increasing energy density, and increasing cooling efficiency of the battery cells. For example, the disclosed solutions allow for a larger volume of active electrolyte material that is used to provide energy for a vehicle as compared to conventional vehicles (e.g., of the same size). Therefore, the disclosed solutions facilitate reducing a footprint (e.g., weight, cost, volume of inactive material) of a vehicle while increasing energy density. Further, the disclosed solutions facilitate cooling battery cells over a greater surface area of the battery cells as compared to conventional techniques. Therefore, the disclosed solutions can facilitate cooling battery cells faster or more efficiently than conventional techniques.

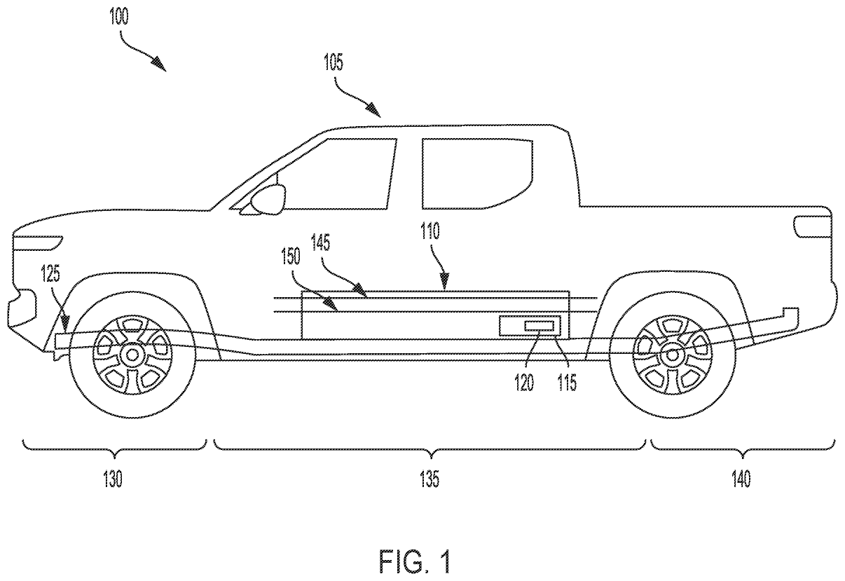

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

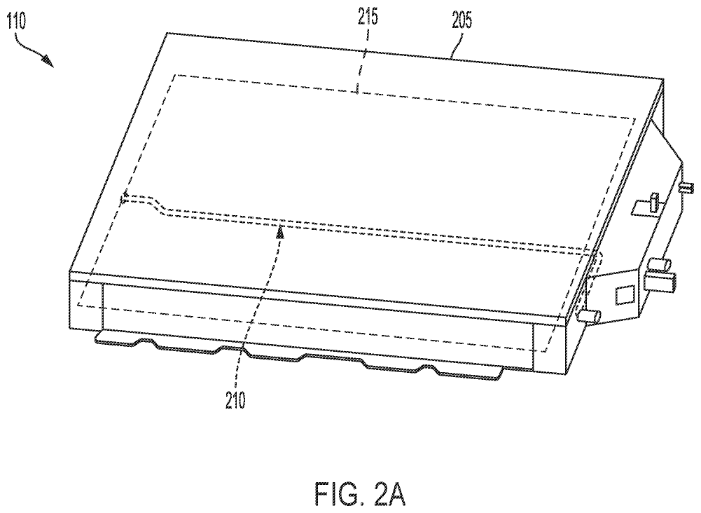

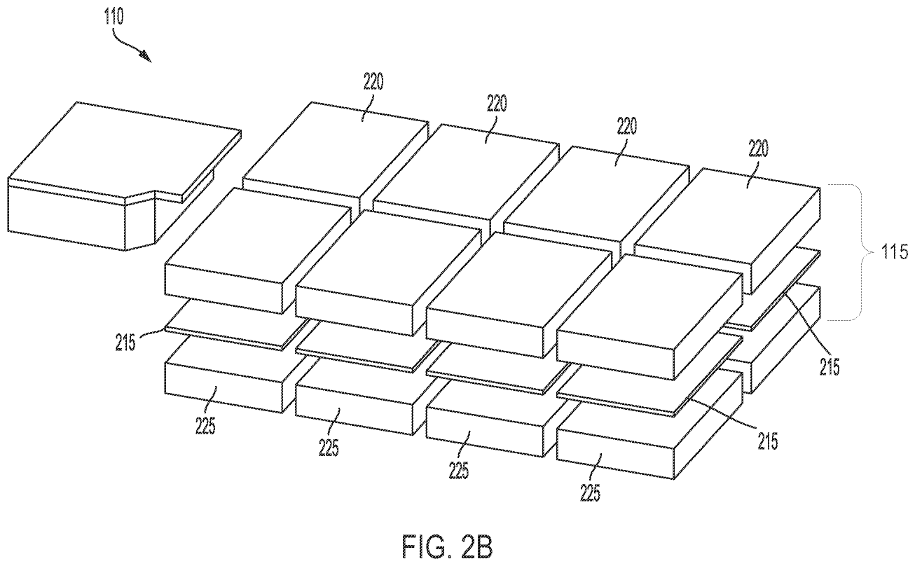

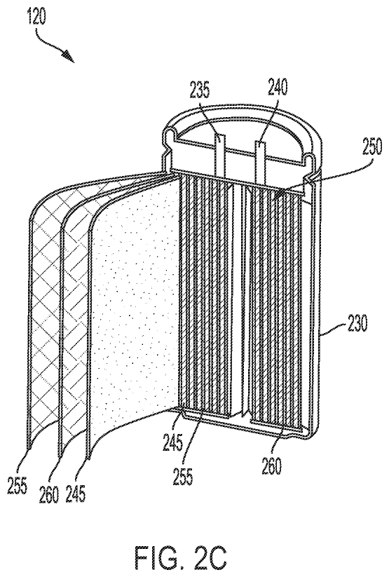

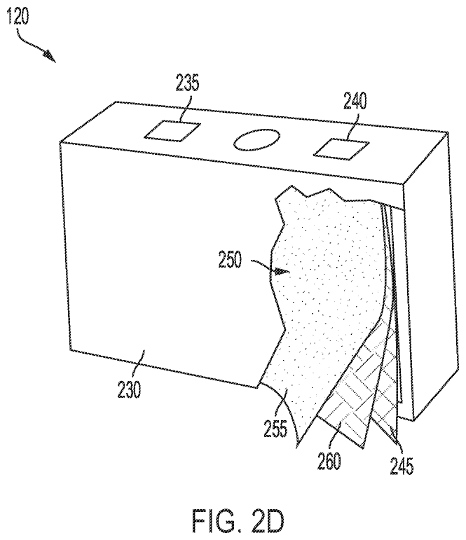

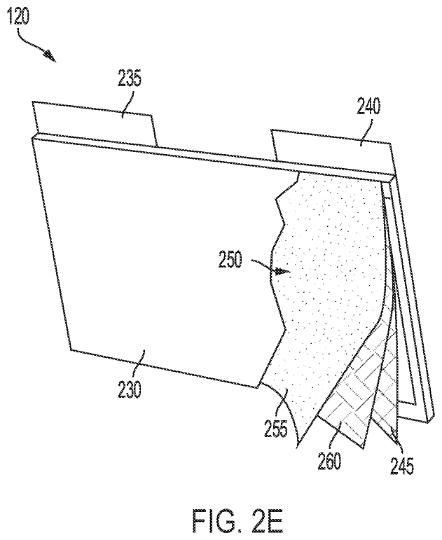

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without modules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. A separator can be wetted with a liquid electrolyte. The liquid electrolyte can be diffused into the anode layer 245. The liquid electrolyte can be diffused into the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fc, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

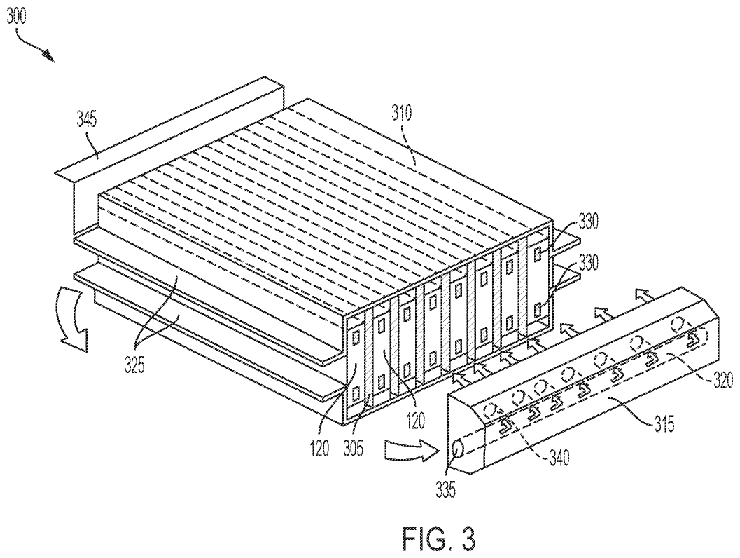

FIG. 3 depicts a perspective view of an apparatus 300, in accordance with an example implementation. The apparatus 300 can include, can be, or can form a portion of a battery. For example, the battery pack 110 of the vehicle 105 can include the apparatus 300. For example, the battery 110 can be module-free and can include the apparatus 300. As another example, the battery 110 can include one or more battery modules 115 that include the apparatus 300.

The apparatus 300 can include at least one battery cell 120. For example, the apparatus 300 can include one battery cell 120, two battery cells 120, three battery cells 120, or more. At least two battery cells 120 of the apparatus 300 can be positioned at a distance from one another such that a space 305 is defined between one battery cell 120 and another battery cell 120. The apparatus 300 can include a plurality of battery cells 120 each separated by a respective space 305. Each space 305 can be the same size or shape, or one or more spaces 305 can differ. For example, each space 305 can be between 0.1-5 mm in width between a first battery cell 120 and a second battery cell 120. This example is for illustrative purposes. The space 305 can be significantly smaller or significantly larger than this example (e.g., 0-200 mm, or another dimension). The apparatus 300 can include one or more types of battery cells 120. For example, the apparatus 300 can include prismatic cells, cylindrical cells, elongated cells, pouch cells, another type of cell, or any combination thereof.

The apparatus 300 can include at least one closure 310. For example, the closure 310 can correspond to a lid component, or a portion of a lid component (e.g., shells). For example, the lid component can be a portion of an enclosure or a subset of an enclosure having a plurality of closures 310. For example, closures 310 can include one or more members of a structure corresponding to a can, a cap, a faceplate, a ring, or any portion or combination thereof. For example, closures 310 can include one or more of a five-sided structure at least partially surrounding a cavity, a one-sided planar structure, and a tubular structure at least partially surrounding a cavity. A closure 310 can be compatible with a cell-to-pack structural battery structure. A closure 310 can be compatible with a battery module 115 battery structure. A closure 310 can include or can be a portion of the battery cell housing 230 to at least partially enclose, surround, or form a pouch cell, a prismatic cell, a cylindrical cell, or any combination thereof. For example, the closure 310 can at least partially surround one or more battery cells 120 and the space 305 between the one or more battery cells 120.

The closure 310 can include one or more components to facilitate enclosing at least one of the battery cells 120. For example, the closure 310 can extend an entirety of a battery cell housing 230 of at least one of the battery cells 120. The closure 310 can include at least one end cap. For example, the closure 310 can include a first end cap 315 at a first end of the closure 310 and a second end cap 345 at a second end of the closure 310. The end caps can be or can include one or more portions of the closure 310 that can facilitate at least partially hermitically scaling the closure 310 (e.g., in a liquid-tight manner on at least one side of the closure 310). For example, the first end cap 315 or the second end cap 345 can include one or more seals, gaskets, or other scaling components coupled with or formed with the end caps. The first end cap 315 or the second end cap 345 can seal the end caps with the closure 310 such that fluid can flow from the end caps through the closure 310, as described herein.

The closure 310 can include at least one flange 325. For example, the closure 310 can include at least one flange 325 that extends from the closure 310. The closure 310 can include two flanges 325, for example. The flanges 325 can be coupled with one another through one or more fasteners, welded joints, adhesives, or other components. The flanges 325 can be sealed with one another to seal off at least a portion of the closure 310. For example, the flanges 325 can be hermetically sealed by one or more sealing components (e.g., seals, gaskets), or one or more bonding components (e.g., welded joints). At least one flange 325 can facilitate coupling the closure 310 with another portion of the vehicle 105. For example, the flanges 325 can extend at least partially away from one or more spaces 305 (e.g., the flanges 325 can protrude from a side of the closure 310, the flanges 325 can protrude in opposing directions) such that one side of at least one flange 325 can engage (e.g., contact, interface, couple with) a first cross beam of the battery pack 110 and another side of at least one flange 325 can engage a second cross beam of the battery pack 110 to couple the closure 310 with the cross beams.

At least a portion of the closure 310 can receive one or more fluids. For example, the first end cap 315 (or the second end cap 345) can include at least one fluid channel. For example, the first end cap 315 can include at least one first fluid channel 320. The first fluid channel 320 can extend through at least a portion of the first end cap 315. For example, the first fluid channel 320 can extend in a direction that is substantially (e.g., within 10%) perpendicular to at least a portion of the battery cells 120. The first fluid channel 320 can receive at least one fluid. For example, the first fluid channel 320 can include at least one inlet 335 that can receive fluid and provide fluid to the first fluid channel 320. The inlet 335 can include one or more openings of the fluid channel 320 to an exterior of the closure 310.

The first fluid channel 320 can facilitate providing the fluid received by the inlet to at least one space 305 between the one or more battery cells 120 within the closure 310. For example, the first fluid channel 320 can include or can fluidly couple with at least one second fluid channel 340 that fluidly couples with at least a portion of the space 305. For example, the first end cap 315 can include the same amount of second fluid channels 340 as the amount of spaces 305 in the closure 310 such that the first fluid channel 320 can provide the fluid to each space 305 of the closure 310. The first end cap 315 can include any amount of first or second fluid channels to facilitate distributing the fluid to the spaces 305.

The second end cap 345 can include at least one first fluid channel 320 and at least one second fluid channel 340 (not visible in FIG. 3) that can receive the fluid. For example, the second end cap 345 can include a similar or identical configuration as the first end cap 315. The second end cap 345 can be or can include at least one outlet such that fluid provided to the inlet 335 of the first end cap 315 can flow through at least a portion of the first fluid channel 320 to flow through at least one of the second fluid channels 340, through at least one corresponding space 305, through a corresponding second fluid channel 340 of the second end cap 345, and out through an outlet of the end cap 345 (e.g., as generally depicted by the arrows in FIG. 3). In other words, each space 305 can be, can include, or can function as a fluid channel to receive the fluid from the first end cap 315 such that fluid flows adjacent to the battery cells 120 (e.g., to contact the battery cells).

The fluid can be, but is not limited, to a coolant. For example, the fluid can be a glycol-based coolant. The fluid (e.g., coolant) can be or can include one or more liquids, gases, or any combination thereof. The fluid can include various other fluids including, but not limited to, a heating fluid. The fluid can contact at least a portion of a first battery cell 120, a portion of the second battery cell 120, or a portion of the closure 310 within the space 305. For example, the fluid can flow under pressure between the first end cap 315 and the second end cap 345 within the space 305 such that at least a portion of the fluid can contact an entirety of a perimeter of the space 305. The fluid can apply pressure to at least a portion of one or more battery cells 120. For example, the fluid can apply pressure of up to 1 MPa or more on at least a portion of a battery cell 120 (e.g., 0.001 MPa, 0.01 MPa, 0.1 MPa, 1 MPa, or more). This example is for illustrative purposes. The fluid can facilitate regulating a temperature of at least one battery cell 120 within the closure 310. For example, the coolant contacting at least a portion of one or more battery cells 120 can facilitate quickly and efficiently cooling the one or more battery cells 120.

As described herein, at least a portion of the closure 310 can contact one or more battery cells 120, or at least a portion of a battery cell 120, to facilitate regulating a temperature of the battery cell 120. For example, the fluid can contact at least a portion of the closure 310. The fluid can facilitate regulating a temperature of the closure 310 (e.g., cooling or heating the closure 310 by conduction). The closure 310 can contact one or more portions of a battery cell 120 within the closure 310 to further cool or heat the battery cell 120 in contact with the closure 310 (e.g., by conduction). For example, the closure 310 can contact a topmost or bottommost portion of a battery cell 120.

The battery cells 120 can extend an entirety of the closure 310 (e.g., such that the longest dimension of the battery cell 120 extends between two ends of the closure 310). The fluid can contact at least a portion of the longest dimension of the battery cell housing 230, for example. The longest dimension of the battery cell 120 can be about less than or equal to 1.5 m (e.g., within 10%). The longest dimension of the battery cell 120 can be substantially smaller or larger than 1.5 m. For example, the longest dimension of the battery cell 120 can be between 1 mm-2.5 m. The battery cells 120 can extend just a portion of the closure 310 such that multiple battery cells 120 can connect in series or in parallel by one or more connections (e.g., by one or more terminals 330 of the battery cells 120).

The fluid can efficiently cool at least one battery cell 120 of the closure 310. For example, the spaces 305 can replace or supplement the thermal component 215 of the battery pack 110 or one or more components of the battery pack 110 (e.g., one or more bladders or compression plates). For example, the pressurized fluid can apply pressure to the battery cells 120 such that compression plates are no longer necessary (e.g., to reduce swelling of the cells). The fluid can more efficiently cool at least one battery cell 120 in comparison to conventional techniques as the fluid can contact a larger surface area of a battery cell 120. For example, the apparatus 300 can cool at least one battery cell 120 up to 80% more efficiently than conventional values (e.g., 5%, 10%, 15%, 20%, or more). This example is for illustrative purposes.

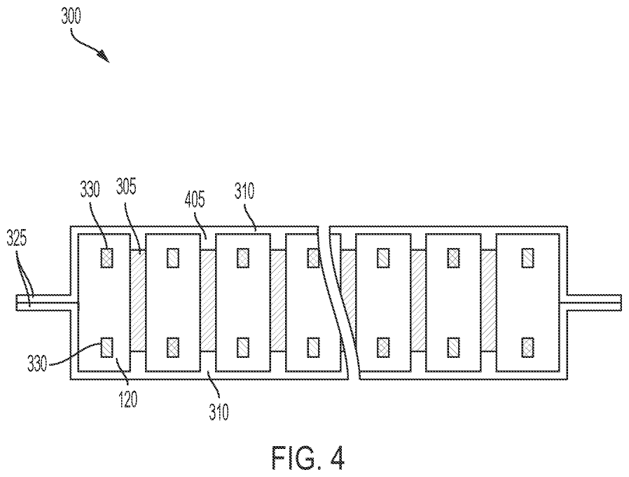

FIG. 4 depicts a side view of a portion of the apparatus 300, according to an example implementation. The closure 310 can include or can couple with at least one tab 405 (e.g., spacers). For example, the tabs 405 can include a portion of the closure 310 that protrude into at least a portion of a space 305. The closure 310 can include at least two tabs 405 that at least partially oppose one another relative to a space 305 (e.g., one tab 405 protrudes from a top of the closure 310 and another tab protrudes from a bottom of the closure 310, as depicted in at least FIG. 4). The tabs 405 can protrude into at least a portion of the space 305 to seal or divide the spaces 305. For example, the tabs 405 can facilitate pressurizing the fluid flowing through the space 305 (e.g., by reducing the volume of the space 305 in comparison to the space 305 without the tabs 405). The tabs 405 can facilitate defining one or more pockets for fluid to flow within the space 305. In some examples, the fluid can flow between one or more spaces 305 (e.g., over, around, under, or through the cells 120). In some examples, the fluid flows independently and separately within the spaces 305 (e.g., without crossing streams within the closure 310).

One or more portions of a battery cell 120 can be rigidly coupled with a portion of the closure 310. For example, a top portion of a battery cell 120 and a bottom portion of a battery cell 120 (e.g., proximate the tabs 405) can couple with the closure 310 by one or more welded joints, bonds, adhesives, or other components to provide stiff structures (e.g., a rigid, substantially predefined volume of the space 305 that may only increase or decrease due to swelling or expanding of the battery cell housings 230). For example, the battery cells 120 can couple with the closure 310 such that at least a portion of the battery cell 120 is fixed to the closure 310 (e.g., may not move or rotate relative to the closure 310).

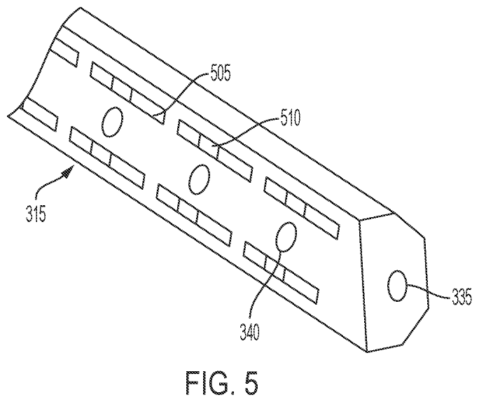

FIG. 5 depicts a perspective view of a portion of the first end cap 315, according to an example implementation. For example, FIG. 5 depicts a perspective view of a side of the first end cap 315 that can couple with the one or more battery cells 120 within the remainder of the closure 310. The first end cap 315 can include at least one electrical connection component 505. For example, the electrical connection component 505 can contact at least one terminal 330 of a battery cell 120 to create an electrical connection between the battery cell 120 and the end cap 315 (e.g., such that electricity can flow between at least one terminal of a battery cell 120 and the electrical connection component 505 of the first end cap 315). The electrical connection component 505 can be or can include one or more at least partially metallic materials to form an electrical connection with a terminal 330. For example, the electrical connection component 505 can be or can include a busbar.

The first end cap 315 can include at least one spacer 510. For example, the spacer 510 can include one or more at least partially insulative materials. The spacer 510 can be disposed adjacent to, or in between, one or more electrical connection components 505 on a surface of the end cap 315. The electrical connection components 505 can be entirely separate from (e.g., independent and isolated from) the one or more fluid channels such that fluid does not directly contact at least one electrical connection components 505 (e.g., such that the electrical connection component 505 does not get wet). For example, the spacers 510 can facilitate maintaining a distance between the electrical connection components 505 and the second fluid channels 340.

The first fluid channel 320, the second fluid channel 340, the electrical connection components 505, or the spacers 510 can vary in size or shape. For example, the first fluid channel 320, the second fluid channel 340, the electrical connection components 505, or the spacers 510 can include any one or more of a round shape, rectangular shape, triangular shape, symmetrical or asymmetrical shape, or various other shapes. The first fluid channel 320 and the second fluid channel 340 can include one or more similar dimensions. For example, the first fluid channel 320 can include the same diameter, perimeter, width, or length as the second fluid channel 340. One or more second fluid channels 340 can extend from a first spacer 510 on a top portion of the first or second end cap to a second spacer 510 on a bottom portion of the first or second end cap (e.g., the second fluid channel 340 can include a rectangular shape between the spacers 510 that can substantially (e.g., within 10%) match the profile of the corresponding space 305 fluidly coupled with the second fluid channel 340.

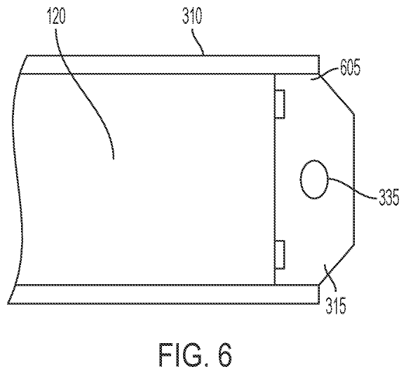

FIG. 6 depicts a side view of a portion of the apparatus 300, according to an example implementation. For example, FIG. 6 depicts a side view of the first end cap 315 coupled with a battery cell 120 within the closure 310. The apparatus 300 can include at least one seal 605 to hermetically seal the first end cap 315 with the battery cell 120 (e.g., to hermitically seal the space 305 between the battery cell 120 and an adjacent battery cell 120). For example, the seal 605 can be or can include one or more seals or gaskets to facilitate joining the end cap 315 with the closure 310. The seal 605 can surround or position adjacent to at least a portion of the perimeter of the first end cap 315 or the second end cap 345. The seal 605 can be one or more plastic materials, elastomer materials, or metallic materials. The first end cap 315 or the second end cap 345 can couple with the closure 310 by one or more bonds, welded joints, adhesives, fasteners, or other techniques.

The apparatus 300 can facilitate reducing a footprint (e.g., and increasing energy density) of the vehicle 105 as compared to conventional vehicles. For example, as described herein, the apparatus 300 can supplement or replace one or more components of a conventional vehicle including, but not limited to, a thermal component (e.g., cold plate), a bladder, or one or more compression plates. Thus, the apparatus 300 can allow for more active material (e.g., electrolyte material within the battery cell 120 that provides energy for the vehicle 105) than conventional vehicles 105. For example, the apparatus 300 can improve energy density of a vehicle between 0-50% (e.g., 5%, 10%, 20%, or more). This example is for illustrative purposes.

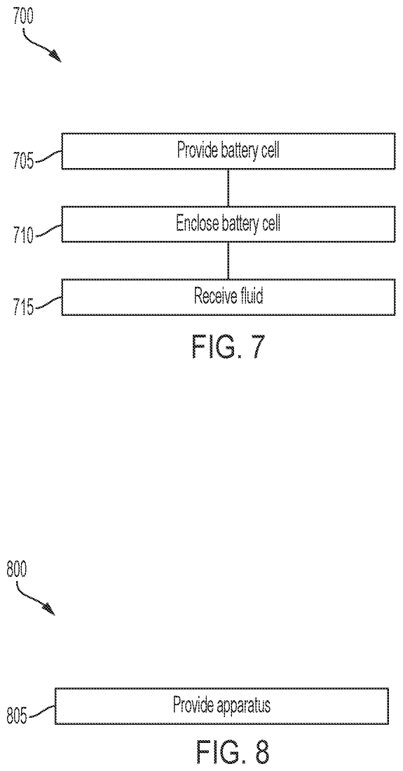

FIG. 7 depicts a method 700, according to an example implementation. The method 700 can include providing at least one battery cell 120, as depicted in act 705. For example, the method 700 can include providing the apparatus 300 having a first battery cell 120 and a second battery cell 120 separated by a distance to define a space 305. The apparatus 300 can include a plurality of battery cells 120 each separated by a respective space 305. Each space 305 can be the same size or shape, or one or more spaces 305 can differ. The spaces 305 can extend throughout at least a portion of the apparatus 300. For example, the space 305 can extend along at least a portion of one or more battery cell housings 230.

The method 700 can include enclosing at least one battery cell 120, as depicted in act 710. For example, the closure 310 can at least partially enclose (e.g., surround, secure, lock, seal) the first battery cell 120, the second battery cell 120, and the space 305 between the cells. For example, the closure 310 can correspond to a lid component, or a portion of a lid component (e.g., shells). For example, the lid component can be a portion of an enclosure or a subset of an enclosure having a plurality of closures 310. For example, closures 310 can include one or more members of a structure corresponding to a can, a cap, a faceplate, a ring, or any portion or combination thereof. For example, closures 310 can include one or more of a five-sided structure at least partially surrounding a cavity, a one-sided planar structure, and a tubular structure at least partially surrounding a cavity. A closure 310 can be compatible with a cell-to-pack structural battery structure. A closure 310 can be compatible with a battery module 115 battery structure. A closure 310 can include or can be a portion of the battery cell housing 230 to at least partially enclose, surround, or form a pouch cell, a prismatic cell, a cylindrical cell, or any combination thereof. For example, the closure 310 can at least partially surround one or more battery cells 120 and the space 305 between the one or more battery cells 120.

The closure 310 can include one or more components to facilitate enclosing at least one of the battery cells 120. For example, the closure 310 can extend an entirety of a battery cell housing 230 of at least one of the battery cells 120. The closure 310 can include at least one end cap. For example, the closure 310 can include a first end cap 315 and a second end cap 345. The end caps can be or can include one or more portions of the closure 310 that can facilitate hermitically sealing the closure 310 (e.g., in a liquid-tight manner on at least one side of the closure 310). For example, the first end cap 315 or the second end cap 345 can include one or more seals, gaskets, or other sealing components coupled with or formed with the end caps.

The method 700 can include receiving a fluid, as depicted in act 715. For example, at least one space 305 within the closure 310 (e.g., between two or more battery cells 120) can receive the fluid. The fluid can be a coolant. The fluid can be various other gases, liquids, or combinations thereof. The space 305 can receive the fluid from one or more fluid channels of the closure 310 (e.g., from the first fluid channel 320 or the second fluid channel 340). For example, the first end cap 315 (or the second end cap 345) can include at least one fluid channel. For example, the first end cap 315 can include at least one first fluid channel 320. The first fluid channel 320 can extend through at least a portion of the first end cap 315. For example, the first fluid channel 320 can extend in a direction that is substantially (e.g., within 10%) perpendicular to at least a portion of the battery cells 120. The first fluid channel 320 can receive at least one fluid. For example, the first fluid channel 320 can include at least one inlet 335 that can receive fluid and provide fluid to the first fluid channel 320. The inlet 335 can include one or more openings of the fluid channel 320 to an exterior of the closure 310.

The first fluid channel 320 can facilitate providing the fluid received by the inlet to at least one space 305 between the one or more battery cells 120 within the closure 310. For example, the first fluid channel 320 can include or can fluidly couple with at least one second fluid channel 340 that fluidly couples with at least a portion of the space 305. For example, the first end cap 315 can include the same amount of second fluid channels 340 as the amount of spaces 305 in the closure 310 such that the first fluid channel 320 can provide the fluid to each space 305 of the closure 310. The first end cap 315 can include any amount of first or second fluid channels to facilitate distributing the fluid to the spaces 305.

The second end cap 345 can include at least one first fluid channel 320 and at least one second fluid channel 340. For example, the second end cap 345 can include a similar or identical configuration as the first end cap 315. The second end cap 345 can be or can include at least one outlet such that fluid provided to the inlet 335 of the first end cap 315 can flow through at least a portion of the first fluid channel 320 to flow through at least one of the second fluid channels 340, through at least one corresponding space 305, through a corresponding second fluid channel 340 of the second end cap 345, and out through an outlet of the end cap 345. In other words, each space 305 can be, can include, or can function as a fluid channel to receive the fluid from the first end cap 315.

The fluid can contact at least a portion of a first battery cell 120, a portion of the second battery cell 120, or a portion of the closure 310 within the space 305. For example, the fluid can flow under pressure between the first end cap 315 and the second end cap 345 within the space 305 such that at least a portion of the fluid can contact an entirety of a perimeter of the space 305. The fluid can apply pressure to at least a portion of one or more battery cells 120. The fluid can facilitate regulating a temperature of at least one battery cell 120 within the closure 310. For example, the coolant contacting at least a portion of one or more battery cells 120 can facilitate quickly and efficiently cooling the one or more battery cells 120.

FIG. 8 depicts a method 800, according to an example implementation. The method 800 can include providing the apparatus 300, as depicted in act 805. For example, the apparatus 300 can include, can be, or can form a portion of a battery. For example, the battery pack 110 of the vehicle 105 can include the apparatus 300. For example, the battery 110 can be module-free and can include the apparatus 300. As another example, the battery 110 can include one or more battery modules 115 that include the apparatus 300.

The apparatus 300 can include at least one battery cell 120. For example, the apparatus 300 can include one battery cell 120, two battery cells 120, three battery cells 120, or more. At least two battery cells 120 of the apparatus 300 can be positioned at a distance from one another such that a space 305 is defined between one battery cell 120 and another battery cell 120. The apparatus 300 can include a plurality of battery cells 120 each separated by a respective space 305. Each space 305 can be the same size or shape, or one or more spaces 305 can differ.

The apparatus 300 can include at least one closure 310. For example, the closure 310 can correspond to a lid component, or a portion of a lid component (e.g., shells). For example, the lid component can be a portion of an enclosure or a subset of an enclosure having a plurality of closures 310. For example, closures 310 can include one or more members of a structure corresponding to a can, a cap, a faceplate, a ring, or any portion or combination thereof. For example, closures 310 can include one or more of a five-sided structure at least partially surrounding a cavity, a one-sided planar structure, and a tubular structure at least partially surrounding a cavity. A closure 310 can be compatible with a cell-to-pack structural battery structure. A closure 310 can be compatible with a battery module 115 battery structure. A closure 310 can include or can be a portion of the battery cell housing 230 to at least partially enclose, surround, or form a pouch cell, a prismatic cell, a cylindrical cell, or any combination thereof. For example, the closure 310 can at least partially surround one or more battery cells 120 and the space 305 between the one or more battery cells 120.

The closure 310 can include one or more components to facilitate enclosing at least one of the battery cells 120. For example, the closure 310 can extend an entirety of a battery cell housing 230 of at least one of the battery cells 120. The closure 310 can include at least one end cap. For example, the closure 310 can include a first end cap 315 and a second end cap 345. The end caps can be or can include one or more portions of the closure 310 that can facilitate hermitically sealing the closure 310 (e.g., in a liquid-tight manner on at least one side of the closure 310). For example, the first end cap 315 or the second end cap 345 can include one or more seals, gaskets, or other sealing components coupled with or formed with the end caps. The first end cap 315 or the second end cap 345 can seal the end caps with the closure 310 such that fluid can flow from the end caps through the closure 310, as described herein.

At least a portion of the closure 310 can receive one or more fluids. For example, the first end cap 315 or the second end cap 345 can include at least one fluid channel. For example, the first end cap 315 can include at least one first fluid channel 320. The first fluid channel 320 can extend through at least a portion of the first end cap 315. The first fluid channel 320 can receive at least one fluid. For example, the first fluid channel 320 can include at least one inlet 335 that can receive fluid and provide fluid to the first fluid channel 320. The inlet 335 can include one or more openings of the fluid channel 320 to an exterior of the closure 310.

The first fluid channel 320 can facilitate providing the fluid received by the inlet to at least one space 305 between the one or more battery cells 120 within the closure 310. For example, the first fluid channel 320 can include or can fluidly couple with at least one second fluid channel 340 that fluidly couples with at least a portion of the space 305. For example, the first end cap 315 can include the same amount of second fluid channels 340 as the amount of spaces 305 in the closure 310 such that the first fluid channel 320 can provide the fluid to each space 305 of the closure 310. The first end cap 315 can include any amount of first or second fluid channels to facilitate distributing the fluid to the spaces 305.

The fluid can be, but is not limited, to a coolant. For example, the fluid can be a glycol-based coolant. The fluid (e.g., coolant) can be or can include one or more liquids, gases, or any combination thereof. The fluid can include various other fluids including, but not limited to, a heating fluid. The fluid can contact at least a portion of a first battery cell 120, a portion of the second battery cell 120, or a portion of the closure 310 within the space 305. For example, the fluid can flow under pressure between the first end cap 315 and the second end cap 345 within the space 305 such that at least a portion of the fluid can contact an entirety of a perimeter of the space 305. The fluid can apply pressure to at least a portion of one or more battery cells 120. The fluid can facilitate regulating a temperature of at least one battery cell 120 within the closure 310. For example, the coolant contacting at least a portion of one or more battery cells 120 can facilitate quickly and efficiently cooling the one or more battery cells 120.

The fluid can efficiently cool at least one battery cell 120 of the closure 310. For example, the spaces 305 can replace or supplement the thermal component 215 of the battery pack 110 or one or more components of the battery pack 110 (e.g., one or more bladders or compression plates). For example, the pressurized fluid can apply pressure to the battery cells 120 such that compression plates are no longer necessary (e.g., to reduce swelling of the cells). The fluid can more efficiently cool at least one battery cell 120 in comparison to conventional techniques as the fluid can contact a larger surface area of a battery cell 120.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the closure and the spaces can include various shapes or configurations to accommodate various types of cells including, but not limited to, prismatic cells, elongated cells, cylindrical cells, pouch cells, or any combination thereof. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a space between a first battery cell and a second battery cell;
a closure to at least partially surround the space; and
the space configured to receive a coolant, the coolant configured to contact at least a portion of the first battery cell and at least a portion of the second battery cell.

2. The apparatus of claim 1, comprising:
the coolant further configured to contact at least a portion of the closure, wherein the closure contacts at least a portion of the first battery cell and at least a portion of the second battery cell to regulate temperature of the first battery cell and the second battery cell.

3. The apparatus of claim 1, comprising:
the closure includes an end cap having a fluid channel to provide the coolant to the space; and
the end cap to at least partially seal the space between the first battery cell and the second battery cell.

4. The apparatus of claim 1, comprising:
the closure includes an end cap having a channel to provide the coolant to the space; and
the end cap includes a busbar that is independent from the channel.

5. The apparatus of claim 1, comprising:
the closure includes a first end cap disposed on a first end of the closure, the first end cap having a first channel to provide the coolant to the space; and
the closure includes a second end cap disposed on a second end of the closure, the second end cap having a second channel to receive the coolant from the space.

6. The apparatus of claim 1, comprising:
the coolant to flow under pressure within the space between the first battery cell and the second battery cell.

7. The apparatus of claim 1, comprising:
a tab coupled with the closure; and
the tab to protrude into a portion of the space between the first battery cell and the second battery cell.

8. The apparatus of claim 1, comprising:
the closure comprises at least one flange that extends at least partially away from the space.

9. A method, comprising:
enclosing, by a closure, a first battery cell and a second battery cell positioned apart from the first battery cell to define a space between the first battery cell and the second battery cell;
providing a coolant to the space between the first battery cell and the second battery cell; and
the coolant to contact at least a portion of the first battery cell and at least a portion of the second battery cell.

10. The method of claim 9, comprising:
providing the coolant to contact at least a portion of the closure, wherein the closure contacts at least a portion of the first battery cell and at least a portion of the second battery cell.

11. The method of claim 9, comprising:
the closure includes an end cap having a fluid channel to provide the coolant to the space; and
the end cap to at least partially seal the space between the first battery cell and the second battery cell.

12. The method of claim 9, comprising:
the closure includes an end cap having a channel to provide the coolant to the space; and
the end cap includes a busbar that is independent from the channel.

13. The method of claim 9, comprising:
the closure includes a first end cap disposed on a first end of the closure, the first end cap having a first channel to provide the coolant to the space; and
the closure includes a second end cap disposed on a second end of the closure, the second end cap having a second channel to receive the coolant from the space.

14. The method of claim 9, comprising:
the coolant to flow under pressure within the space between the first battery cell and the second battery cell.

15. The method of claim 9, comprising:
a tab coupled with the closure; and
the tab to protrude into a portion of the space between the first battery cell and the second battery cell.

16. The method of claim 9, comprising:
the closure comprises at least one flange that extends at least partially away from the space.

17. A battery, comprising:
a first battery cell positioned apart from a second battery cell to define a space between the first battery cell and the second battery cell;
a closure to at least partially contact at least a portion the first battery cell and at least a portion of the second battery cell so as to at least partially enclose the space; and
the closure to at least partially enclose a coolant to cool at least the portion of the first battery cell and at least the portion of the second battery cell.

18. The battery of claim 17, comprising:
the coolant further configured to contact the first battery cell and the second battery cell.

19. The battery of claim 17, comprising:
the closure includes a first end cap disposed on a first end of the closure, the first end cap having a first channel to provide the coolant to the space; and
the closure includes a second end cap disposed on a second end of the closure, the second end cap having a second channel to receive the coolant from the space.

20. The battery of claim 17, comprising:
a tab coupled with the closure; and
the tab to protrude into a portion of the space between the first battery cell and the second battery cell.
